(19) United States
(12) Patent Application Publication
(10) Pub. No.: US 2013/0300695 A1
(43) Pub. Date: Nov. 14, 2013

(54) MATRIX SWITCHING TYPE PRESSURE-SENSITIVE TOUCH DETECTING DEVICE

(71) Applicant: CRUCIALTEC CO., LTD., Choonghungnam-do (KR)

(72) Inventors: Hyung Sik CHO, Gyeonggi-do (KR); Bo Eun KANG, Incheon (KR)

(73) Assignee: CRUCIALTEC CO., LTD., Choonghungnam-do (KR)

(21) Appl. No.: 13/891,069

(22) Filed: May 9, 2013

(30) Foreign Application Priority Data
May 11, 2012 (KR) 10-2012-0050161

(51) Int. Cl. G06F 3/044

(52) U.S. Cl. CPC G06F 3/044
USPC 345/173

(57) ABSTRACT

A matrix switching type pressure-sensitive touch detecting device has a simple configuration. The matrix switching type pressure-sensitive touch detecting device may include an upper substrate, a lower substrate, and a unified sensor module disposed between the upper substrate and the lower substrate. The unified sensor module includes a touch sensor having a plurality of transparent touch electrodes disposed at a patterning portion of a lower surface of the upper substrate in a matrix pattern and a transparent pressure sensor in which a first electrode or a second electrode is patterned at the same layer as the touch electrodes

### CROSS-REFERENCE TO RELATED APPLICATION

This application claims priority to Korean Patent Application No. 10-2012-0050161, filed on May 11, 2012, and all the benefits accruing therefrom under 35 U.S.C. §119, the content of which in its entirety is herein incorporated by reference.

### BACKGROUND

1. Field of the Invention

The disclosure relates to a matrix switching type pressure-sensitive touch detecting device, and more particularly, to a matrix switching type pressure-sensitive touch detecting device having a simple configuration.

2. Discussion of Related Art

In general, touchscreen devices refer to input devices that detect a touch position of a user on a display screen, input information about the detected touch position, and have overall control of an electronic instrument including control of the display screen.

These touchscreen devices include a resistive type, a capacitive type, an ultrasonic type, a light (infrared light) sensor type, and an electromagnetic induction type. These types may be appropriately selected according to a problem on signal amplification, a difference in resolution, a level of difficulty of design and processing technology, and so on.

Specifically, the types of the touchscreen devices may be selected in consideration of durability and economic efficiency in addition to optical properties, mechanical properties, environment-resistant characteristics, and input characteristics.

Meanwhile, the capacitive type touchscreen device is a type that is driven by detecting static electricity generated from a human body.

In the capacitive type touchscreen device, both surfaces of a transparent substrate are coated with transparent conductive metal, and a high frequency is propagated on a surface of a touchscreen when voltage is applied to four corners of the touchscreen. When a conductor such as a finger is touched on a transparent electrode of the substrate, a predetermined capacitive layer is formed. A reaction occurs by generating a signal through the capacitive layer and detecting a position.

This capacitive type touchscreen device has a multi-touch function, a high light transmittance of 90% or more, and excellent durability and touch sensitivity. However, the capacitive type touchscreen device has low touch precision, and a limited input type because only a conductor should be used as an input tool.

Meanwhile, touchscreen devices having a capacitive touch module and a pressure detection module capable of detecting a pressure have recently been developed.

The conventional capacitive touchscreen devices capable of detecting the pressure have problems in that a thickness is thick and that a configuration and a manufacturing process are complicated, because a plurality of elements are stacked and a driver integrated circuit (IC) is installed on each element.

### SUMMARY

The disclosure provides a matrix switching type pressure-sensitive touch detecting device having a simple configuration.

In one aspect, there is provided a matrix switching type pressure-sensitive touch detecting device, which includes: an upper substrate; a lower substrate located at a lower side of the upper substrate and spaced apart from the upper substrate by a predetermined interval; and an unified sensor module that is disposed between the upper substrate and the lower substrate, and that includes a touch sensor having a plurality of transparent touch electrodes disposed at a patterning portion of a lower surface of the upper substrate in a matrix pattern and a transparent pressure sensor in which a first electrode or a second electrode is patterned at the same layer as the touch electrodes.

In an example, the pressure sensor may include: the first electrode located at an edge portion of the lower surface of the upper substrate; the second electrode formed so as to face the first electrode and patterned so as to be insulated from the touch electrodes; and an elastic dielectric layer disposed between the first electrode and the second electrode.

In an example, the pressure sensor may include: the first electrode surrounding the touch electrodes patterned on the lower surface of the upper substrate, and patterned so as to be insulated from the touch electrodes; the second electrode disposed between the first electrode and the lower substrate; and an elastic dielectric layer disposed between the first electrode and the second electrode.

Also, the elastic dielectric layer may be a double-sided adhesive tape having a dielectric property.

In addition, the lower substrate may be a liquid crystal display (LCD) module.

According to the aspect, at least one of a first electrode and a second electrode of the pressure sensor is patterned at the same layer as the touch electrodes. Thus, a thickness of the touch detecting device can be reduced. As a structure of the touch detecting device becomes simple, a manufacturing process can be simplified, and a manufacturing cost can be reduced.

Further, the unified sensor module includes a unified integrated circuit (IC) that can recognize a touch signal detected by the touch sensor and a pressure signal detected by the pressure sensor. Thus, a configuration of the touch detecting device can be further simplified.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is an exploded perspective view showing a matrix switching type pressure-sensitive touch detecting device according to a first aspect;

FIG. 2 is a cross-sectional view showing the matrix switching type pressure-sensitive touch detecting device according to the first aspect;

FIG. 3 is a perspective view showing a lower surface of an upper substrate of the matrix switching type pressure-sensitive touch detecting device according to the first aspect.

FIG. 4 is an exploded perspective view showing a matrix switching type pressure-sensitive touch detecting device according to a second aspect;

FIG. 5 is a cross-sectional view showing the matrix switching type pressure-sensitive touch detecting device according to the second aspect;

FIG. 6 is a perspective view showing a lower surface of an upper substrate of the matrix switching type pressure-sensitive touch detecting device according to the second aspect;

FIG. 7 is an exploded perspective view showing a touch detecting device according to a third aspect; and

FIG. 8 is a block diagram showing a configuration of the touch detecting device according to the third aspect.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

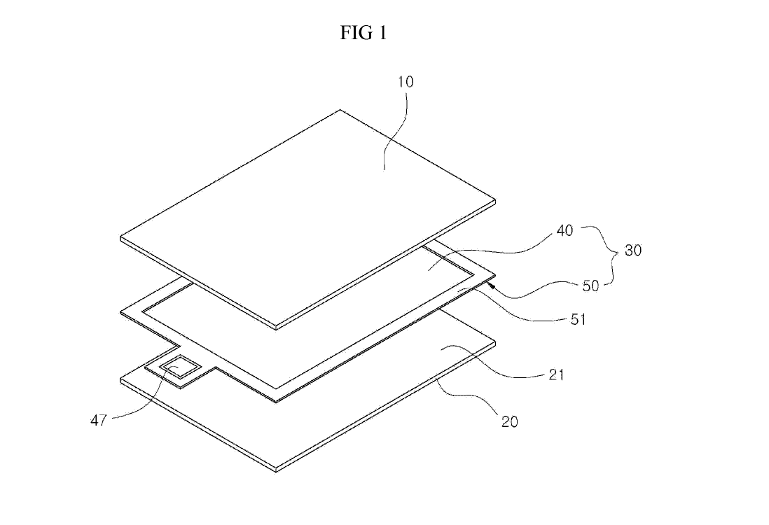

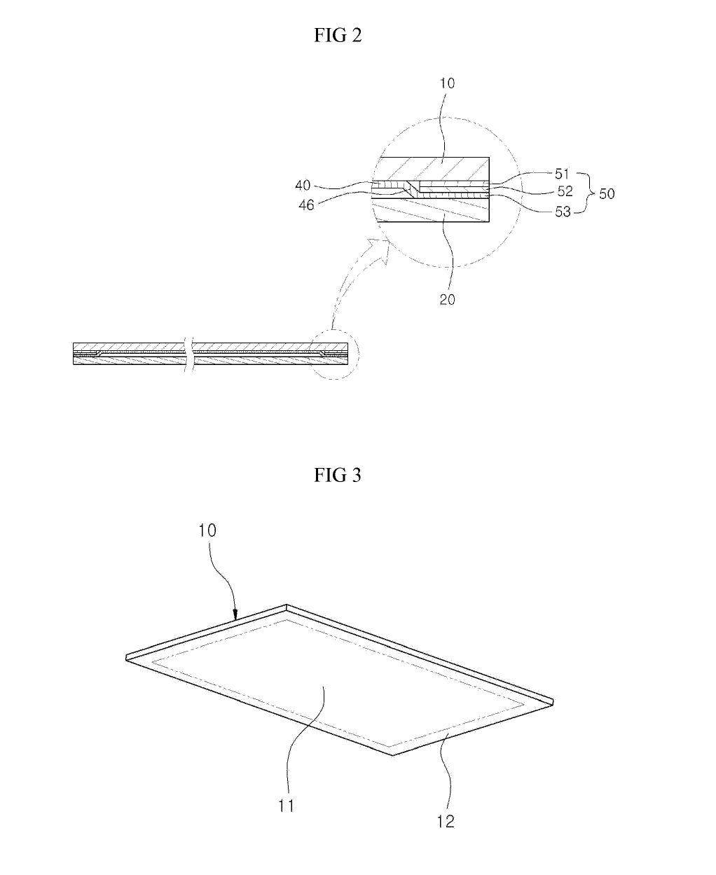

FIGS. 1 and 2 are an exploded perspective view and a cross-sectional view showing a matrix switching type pressure-sensitive touch detecting device, and FIG. 3 is a perspective view showing a lower surface of an upper substrate of the matrix switching type pressure-sensitive touch detecting device.

As shown in FIGS. 1 to 3, the touch detecting device may include an upper substrate 10, a lower substrate 20, and a unified sensor module 30.

Here, the upper substrate 10 may be formed in a flat panel shape, be formed of a material such as glass, be disposed on the top of the touch detecting device to be touched by a user.

A patterning portion 11 and an edge portion 12 may be formed on a lower surface of the upper substrate 10.

Here, the edge portion 12 is formed along an edge of the lower surface of the upper substrate 10, and the patterning portion 11 is a portion other than the edge portion 12.

Thus, the edge portion 12 may be formed so as to surround the patterning portion 11.

The lower substrate 20 may be located at a lower side of the upper substrate 10 so as to be spaced apart from the upper substrate 10 by a predetermined interval.

Further, the unified sensor module 30 may be disposed between the upper substrate 10 and the lower substrate 20.

The unified sensor module 30 may include a touch sensor 40 and a pressure sensor 50.

Here, the touch sensor 40 may be located under the patterning portion 11 of the lower surface of the upper substrate 10.

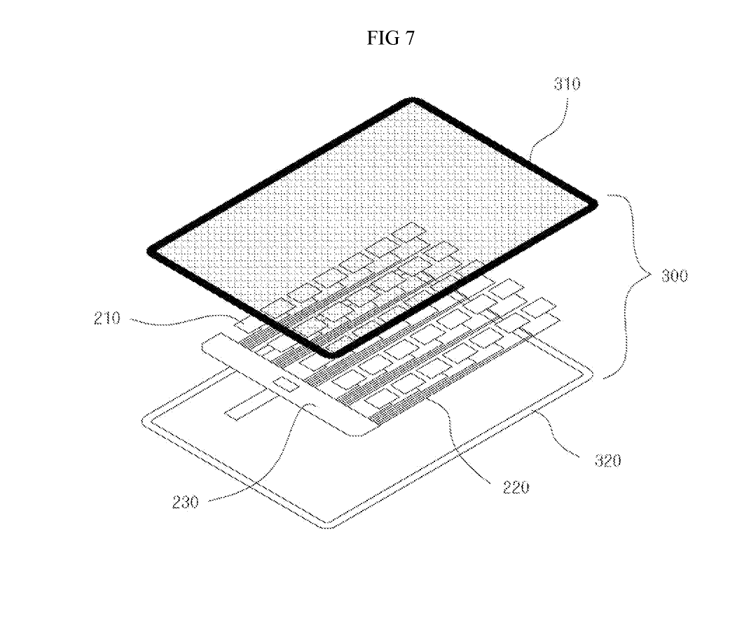

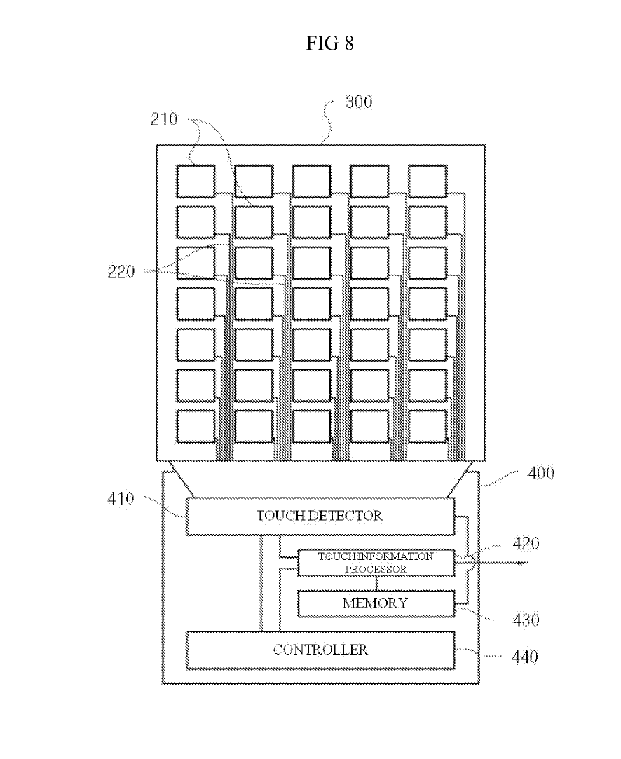

Further, the touch sensor 40 may include a plurality of transparent touch electrodes, for example, of a plurality of sensor pads shown in FIG. 7, disposed in a matrix shape.

The touch electrodes of the touch sensor 40 may be formed by patterning a transparent indium tin oxide (ITO) film, particularly a central portion of the ITO film as a whole.

Here, the central portion of the ITO film is a portion that occupies most of the ITO film excluding an edge of the ITO film which is to be patterned into a second electrode 53 to be described below.

Further, the pressure sensor 50 may be disposed between the edge portion 12 of the lower surface of the upper substrate 10 and an edge portion of an upper surface 21 of the lower substrate 20.

The pressure sensor 50 may include a first electrode 51, an elastic dielectric layer 52, and the second electrode 53.

Here, the first electrode 51 may be located at the edge portion 12 of the lower surface of the upper substrate 10, and be patterned by at least one of depositing and printing methods.

The second electrode 53 may be patterned so as to face the first electrode 51 and to be insulated from the touch electrodes.

For example, the second electrode 53 may be formed by patterning the edge of the ITO film whose central portion are patterned into the touch electrodes of the touch sensor 40.

An insulating portion 46 may be located between the touch electrodes and the second electrode 53 so that the touch electrodes and the second electrode 53 are insulated from each other. Here, the insulating portion 46 may be formed by bonding a dielectric substance having adhesion.

The second electrode 53 may be formed in a shape that corresponds to the first electrode 51 or has a width different from that of the first electrode 51.

In addition, the second electrode 53 may be patterned when the touch electrodes are patterned. Thereby, a process of forming the second electrode 53 can be simplified.

Further, the elastic dielectric layer 52 may be disposed between the first electrode 51 and the second electrode 53 so that the first electrode 51 and the second electrode 53 are not directly connected to each other.

To this end, the elastic dielectric layer 52 may be formed in a shape corresponding to the first electrode 51.

Furthermore, the elastic dielectric layer 52 may be shaped of a double-sided adhesive tape having a dielectric property. Thus, the elastic dielectric layer 52 may adhere to the first electrode 51 and the second electrode 53 so as to be layered between the first electrode 51 and the second electrode 53.

Alternatively, the elastic dielectric layer 52 may be formed so as to cover the entire first electrode 51.

The elastic dielectric layer 52 may be elastically deformed so that a thickness thereof varies depending on a pressure level applied to the upper substrate 10. The pressure level can be detected by an amount of capacitance change depending on a variation in thickness.

Thus, the pressure level can be detected in the event of a touch caused by a nonconductive input tool, so that a user-friendly emotional touch is possible.

In this way, the second electrode 53 of the pressure sensor 50 can be patterned at the same layer as the touch electrodes, so that a thickness of the touch detecting device can be reduced.

Further, since the second electrode 53 can be patterned when the ITO film is patterned into the touch electrodes without a separate process, the process of forming the second electrode 53 can be simplified.

In addition, since one ITO film is patterned into the touch electrodes and the second electrode 53, the touch detecting device may be made up of three layers of the upper substrate 10, the unified sensor module 30, and the lower substrate 20, so that it can be simplified in structure.

Since the first electrode 51, the second electrode 53, and the elastic dielectric layer 52 may be formed transparently, the pressure sensor 50 may be formed transparently. As such, the touch detecting device can be realized without a bezel, i.e. with a zero bezel.

Meanwhile, the lower substrate 20 may be an upper portion of a display device, for instance a liquid crystal display (LCD) module.

Thus, when the touch detecting device is located at an upper portion of the LCD module, the touch detecting device may be made up of two layers of the upper substrate 10 and the unified sensor module 30, so that it can provide a thinner thickness.

Moreover, the unified sensor module 30 may include a unified integrated circuit (IC) 47 that can recognize a touch signal detected by the touch sensor 40 and a pressure signal detected by the pressure sensor 50 at the same time. Thus, the touch detecting device can be further simplified in structure.

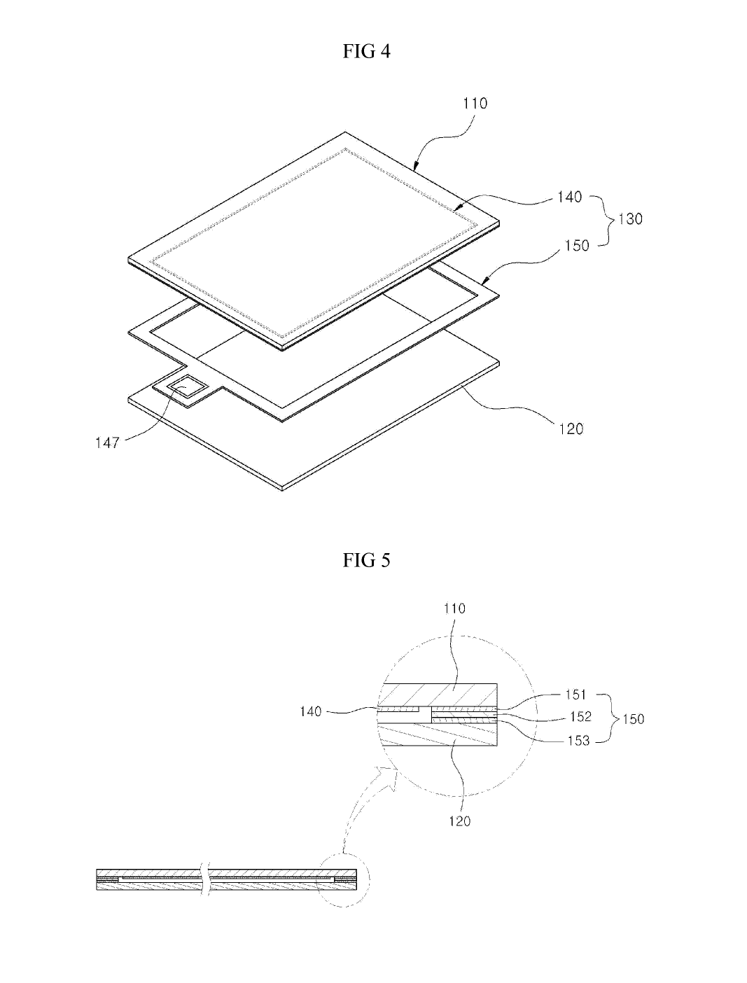

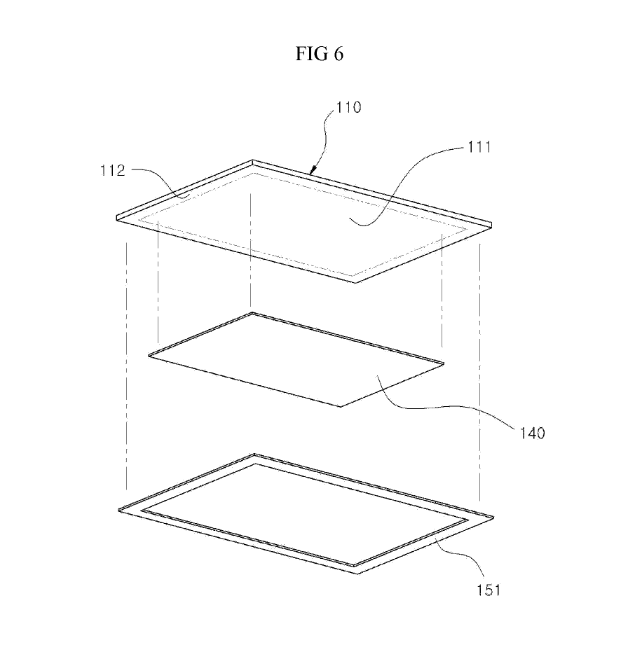

FIGS. 4 and 5 are an exploded perspective view and a cross-sectional view showing a matrix switching type pressure-sensitive touch detecting device according to a second aspect, and FIG. 6 is a perspective view showing a lower surface of an upper substrate of the matrix switching type pressure-sensitive touch detecting device according to the second aspect.

In the matrix switching type pressure-sensitive touch detecting device according to the second aspect, touch electrodes and a first electrode may be patterned at the same layer, and the other components are the same as described above.

As shown in FIGS. 4 to 6, the touch electrodes (not shown) of a touch sensor 140 may be patterned on a lower surface of an upper substrate 110.

The first electrode 151 of a pressure sensor 150 may be patterned so as to be insulated from the touch electrodes.

Here, the touch electrodes may be directly patterned at a patterning portion 111 of the lower surface of the upper substrate 110. The first electrode 151 may be directly patterned at an edge portion 112 of the upper substrate 110.

Thereby, the first electrode 151 may be disposed so as to surround the touch sensor 140, and the first electrode 151 and the touch sensor 140 may be formed at the same layer.

Here, the first electrode 151 may be patterned when the touch electrodes of the touch sensor 140 are directly patterned at the patterning portion 111 of the upper substrate 110. Thereby, a process of forming the first electrode 151 can be simplified.

Further, the elastic dielectric layer 152 may be disposed between the first electrode 151 and the second electrode 153 so that the first electrode 151 and the second electrode 153 are not directly connected to each other.

To this end, the elastic dielectric layer 152 may be formed in a shape that corresponds to the first electrode 151 or covers the first electrode 151 as a whole.

Furthermore, the elastic dielectric layer 152 may be shaped of a double-sided adhesive tape having a dielectric property. Thus, the elastic dielectric layer 152 may adhere to the first electrode 151 and the second electrode 153 so as to be layered between the first electrode 151 and the second electrode 153.

The second electrode 153 may be patterned on a lower substrate 120 by at least one of depositing and printing methods.

In this way, when the touch electrodes are patterned on the lower surface of the upper substrate 110, the first electrode 151 of the pressure sensor 150 can be patterned on the upper substrate 110. Thus, the process of forming the first electrode 151 can be simplified.

In addition, since both the touch electrodes and the first electrode 151 are patterned on the lower surface of the upper substrate 110, they can form the same layer.

Thus, the touch detecting device may be made up of three layers of the upper substrate 110, the unified sensor module 130, and the lower substrate 120, so that it can be simplified in structure and be reduced in thickness.

Further, when the touch detecting device is located at an upper portion of an LCD module, the touch detecting device may be made up of two layers of the upper substrate 110 and the unified sensor module 130, so that it can provide a thinner thickness.

Furthermore, the unified sensor module 130 may include a unified IC 147 that can recognize a touch signal detected by the touch sensor 140 and a pressure signal detected by the pressure sensor 150 at the same time. Thus, the touch detecting device can be further simplified in structure.

A matrix switching type touch detecting device will be described in detail with reference to FIGS. 7 and 8.

FIG. 7 is an exploded perspective view showing the matrix switching type touch detecting device, and FIG. 8 is a block diagram showing a configuration of the matrix switching type touch detecting device.

Referring to FIGS. 7 and 8, the matrix switching type touch detecting device may include a touch panel 300, a driver 400, and a circuit board 230 connecting the touch panel 300 and the driver 400.

The touch panel 300 may include a plurality of sensor pads 210 formed on a substrate 320, and a plurality of signal wirings 220 connected to the sensor pads 210, and the substrate 320 may be formed of a transparent material such as glass or a plastic film.

For example, the plurality of sensor pads 210 may have a quadrangular or rhombic shape, or a shape other than the quadrangular or rhombic shape, for instance a uniform polygonal shape. The sensor pads 210 may be arranged in a matrix pattern in which polygons are adjacent to one another. The sensor pads 210 in a matrix pattern are each driven by signal through the signal wirings 220.

Each signal wiring 220 is configured so that one end thereof is connected to the corresponding sensor pad 210, and the other end thereof extends to a lower edge of the substrate 320. Each signal wiring 220 may be formed at a considerably narrow line width of several micrometers to tens of micrometers.

The sensor pads 210 and the signal wirings 220 may be formed of a transparent conductive material such as indium tin oxide (ITO), antimony tin oxide (ATO), indium zinc oxide (IZO), carbon nanotube (CNT), graphene, or the like. The sensor pads 210 in a matrix pattern and the signal wirings 220 may be a single layer. The sensor pads 210 and the signal wirings 220 may be simultaneously formed by laminating, for instance, an ITO film on the substrate 320 using a method such as sputtering, and then patterning the ITO film using an etching method such as photolithography. The substrate 320 may be formed of a transparent film.

Meanwhile, the sensor pads 210 and the signal wirings 220 may be directly patterned on a cover glass 310. In this case, since the cover glass 310, the sensor pads 210, and the signal wirings 220 are formed in one body, the substrate 320 can be omitted.

The driver 400 for driving the touch panel 300 may be formed on the circuit board 230 such as a printed circuit board or a flexible circuit film, but it is not limited thereto. Thus, the driver 400 may be directly mounted on a part of the substrate 320 or the cover glass 310. The driver 400 may include a touch detector 410, a touch information processor 420, a memory 430, and a controller 440, and may be implemented as at least one integrated circuit (IC) chip. The touch detector 410, the touch information processor 420, the memory 430, and the controller 440 may be configured to be separated from one another or to be used in combination of two or more.

The touch detector 410 may include at least one switch selectively connected to the sensor pads 210 and the signal wirings 220, and at least one drive capacitor. The touch detector 410 pre-charges each of sensor pads 210 using the at least one switch, and isolates charge. Then, pulse signal is applied through the at least one drive capacitor. Here, the touch detector 410 detects a touch from voltage change at rise time or fall time of the pulse signal.

Further, the touch detector 410 may include an amplifier and an analog-to-digital converter, convert, amplify, or digitize a difference in voltage change of each sensor pad 210, and store digital voltage based on the converted, amplified, or digitized difference in the memory 430.

The touch information processor 420 processes the digital voltage stored in the memory 430 and generates necessary information such as whether or not a touch occurs, a touch area, and touch coordinates.

The controller 440 controls the touch detector 410 and the touch information processor 420. The controller 440 may include a micro control unit (MCU) and perform a designated signal processing using a firmware.

The memory 430 stores the digital voltage based on the converted, amplified, or digitized difference detected by the touch detector 410, and preset data used to detect the touch and to calculate the touch area and the touch coordinates, or data received in real time.

By means of the above-described components, a matrix switching type touch detecting device may detect a multi-touch using only single-layered sensor pads 210. Also one of a first electrode and a second electrode in a pressure sensor may be patterned at the same layer as the sensor pads 210.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents. For example, the components described in a combined type may be implemented in a distributed type. Similarly, the components described in a distributed type may be implemented in a combined type.

What is claimed is:

1. A matrix switching type pressure-sensitive touch detecting device comprising:
an upper substrate;
a lower substrate located at a lower side of the upper substrate and spaced apart from the upper substrate by a predetermined interval; and
a unified sensor module disposed between the upper substrate and the lower substrate, the unified sensor module comprising a touch sensor having a plurality of transparent touch electrodes disposed at a patterning portion of a lower surface of the upper substrate in a matrix pattern and a transparent pressure sensor in which a first electrode or a second electrode is patterned at the same layer as the touch electrodes.

2. The matrix switching type pressure-sensitive touch detecting device of claim 1, wherein the pressure sensor comprises:
the first electrode located at an edge portion of the lower surface of the upper substrate;
the second electrode formed so as to face the first electrode and patterned so as to be insulated from the touch electrodes; and
an elastic dielectric layer disposed between the first electrode and the second electrode.

3. The matrix switching type pressure-sensitive touch detecting device of claim 1, wherein the pressure sensor comprises:
the first electrode surrounding the touch electrodes patterned on the lower surface of the upper substrate, and patterned so as to be insulated from the touch electrodes;
the second electrode disposed between the first electrode and the lower substrate; and
an elastic dielectric layer disposed between the first electrode and the second electrode.

4. The matrix switching type pressure-sensitive touch detecting device of claim 2, wherein the elastic dielectric layer is a double-sided adhesive tape having a dielectric property.

5. The matrix switching type pressure-sensitive touch detecting device of claim 2, wherein the lower substrate is a liquid crystal display (LCD) module.

6. The matrix switching type pressure-sensitive touch detecting device of claim 3, wherein the elastic dielectric layer is a double-sided adhesive tape having a dielectric property.

7. The matrix switching type pressure-sensitive touch detecting device of claim 3, wherein the lower substrate is a liquid crystal display (LCD) module.

8. The matrix switching type pressure-sensitive touch detecting device of claim 1, wherein the first electrode is patterned at the same layer as the touch electrodes.

9. The matrix switching type pressure-sensitive touch detecting device of claim 1, wherein the second electrode is patterned at the same layer as the touch electrodes.

10. The matrix switching type pressure-sensitive touch detecting device of claim 1, wherein the lower surface of the upper substrate comprises the patterning portion and an edge portion surrounding the patterning portion; and
the pressure sensor is disposed between the edge portion of the lower surface of the upper substrate and an edge portion of an upper surface of the lower substrate.

11. The matrix switching type pressure-sensitive touch detecting device of claim 2, wherein an insulating portion is located between the touch electrodes and the second electrode to insulate the touch electrodes from the second electrode.

12. The matrix switching type pressure-sensitive touch detecting device of claim 1, having a three-layer structure with the upper substrate, the lower substrate and the unified sensor module.
